(19) United States
(12) Patent Application Publication
(10) Pub. No.: US 2008/0115609 A1
(43) Pub. Date: May 22, 2008

(54) Circulation System for a Ball Screw

(76) Inventors: Chien-Wei TSOU, Taichung (TW); Wen-Chia WU, Taichung (TW)

Correspondence Address: Dr. BANGER SHIA, 102 Lindencrest Ct., Sugar Land, TX, 77479-5201, US

(21) Appl. No.: 11/561,373

(22) Filed: Nov. 17, 2006

(51) Int. Cl. F16H 25/22

(52) U.S. Cl. 74/424.87

(57) ABSTRACT

A circulation system for a ball screw comprises: a screw, a nut, a plurality of return assemblies and balls. The positioning groove of the nut is axially formed with an abutting surface for mating with the return assemblies, in the abutting surface is formed a tapered hole for connecting the through hole, and the abutting surface doesn't interfere with the helical groove, on the open end of the returning assemblies connecting to the through hole is formed a protruding turning structure to be engaged in the tapered hole. The design of the return assembly of the present invention can solve the problem that the radius of curvature of the conventional return path is relatively small and the positioning groove destroys the helical groove, thus increasing the radius of curvature of the return path, and relatively improving the ease of rolling of the balls during circulation.

### BACKGROUND OF THE INVENTION

1. Field of the Invention

The present invention relates to a circulation system for a ball screw, and more particularly to a circulation system, wherein a positioning groove of the nut is axially formed with an abutting surface having a tapered a hole for mating with a turning structure of the return assembly, so that the positioning groove can avoid and doesn't interfere with the helical groove, meanwhile, the radius of curvature of the return path can be increased.

2. Description of the Prior Art

Ball screw is such a mechanism that its nut is mounted onto a screw, and then a plurality of balls circulate between the screw and the nut to produce relative motion.

To enable the balls in a circulation space between the screw and the nut to make a turn, a return assembly should be disposed in the inner threads of the nut, so that the balls can make a turn and circulate endlessly.

Currently, the existing methods for enabling circulation of the balls include: outer circulation, wherein the balls are guided out of the nut to make a turn therefrom; or inner circulation, wherein the balls circulate directly within the inner threads of the nut, or cassette circulation, wherein the balls are guided from the inner threads of the nut to the passage thereof.

FIGS. 1 and 2 show a cassette circulation type ball screw, wherein the return assembly 10 must have a mounting portion 101 to be fixed on the nut by screws, and a return path 104 defined by a leading end 102 and a turning end 103. For the design of this return assembly 10, the lead of the ball screw cannot be too short, otherwise the tip of the next thread will be damaged due to the lead is too short and the tip of thread is too small.

To solve the abovementioned problem of damage to the tip of thread, another return assembly 20 was made that has a special compensating portion 201, as shown in FIGS. 3 and 4, and the compensating portion 201 is used to compensate the damaged portion of the tip of the thread, thus forming an intact thread.

However, since the return assembly 20 with the compensating portion 201 can only be separated into two parts 202 and 203, and the return path of the return assembly 20 for enabling the balls to make a return is limited and still cannot be designed to be too large. If the return path is too small, the balls cannot roll smoothly through it.

Further, whatever the return assembly is unitary or separable, as shown in FIG. 2, and although a compensating portion 105 is formed at the turning end 103 of the return path to compensate the damaged portion of the tip of the thread, the radius of the arc defined by the turning end 103 will be too small to enable the balls to roll smoothly through the return path. Inevitably, the motion of the balls with respect to the screw and the nut will be adversely affected, resulting in a decrease in the mechanical efficiency of the ball screw.

The present invention has arisen to mitigate and/or obviate the afore-described disadvantages.

### SUMMARY OF THE INVENTION

The primary objective of the present invention is to provide a circulation system for a ball screw, and more particularly to a circulation system, wherein a positioning groove of the nut is axially formed with an abutting surface having a tapered a hole for mating with a turning structure of the return assembly such that the positioning groove doesn't destroy the helical groove while not interfering with the helical groove, further, the radius of curvature of the return path can be increased, and thus improving the ease of rolling of the balls during circulation.

To obtain the abovementioned objective, a circulation system for a ball screw in accordance with the present invention comprises: a screw, a nut, a plurality of return assemblies and balls. The positioning groove of the nut is axially formed with an abutting surface for mating with the return assemblies, in the abutting surface is formed a tapered hole for connecting the through hole, and the abutting surface doesn't interfere with the helical groove, on the open end of the returning assemblies connecting to the through hole is formed a protruding turning structure to be engaged in the tapered hole.

By such arrangements, the design of the return assembly of the present invention can solve the problem that the radius of curvature of the conventional return path is relatively small and the positioning groove destroys the helical groove, thus increasing the radius of curvature of the return path, and relatively improving the ease of rolling of the balls during circulation.

Further, the return assembly in accordance with a second embodiment of the present invention can be axially divided into two separable parts that are connected by dovetail groove and dovetail tongue connection.

In addition, the return assembly in accordance with a third embodiment of the present invention can also be radially divided into two separable parts that are connected by pin and socket connection.

### BRIEF DESCRIPTION OF THE DRAWINGS

FIG. 1 is an illustrative view of showing a first conventional return assembly and a nut;

FIG. 2 is a front view of the first conventional return assembly;

FIG. 3 is an exploded view of a second conventional return assembly;

FIG. 4 is a cross sectional assembly view of the second conventional return assembly;

FIG. 5 is an assembly view of a return assembly in accordance with the present invention;

FIG. 6 is an exploded view of a part of the return assembly in accordance with the present invention;

FIG. 7 is an assembly view of a part of the return assembly in accordance with the present invention;

FIG. 8 is a side view of showing a nut and the return assembly in accordance with the present invention;

FIG. 9 is an exploded cross sectional view taken along line A-A′ of FIG. 8;

FIG. 10 is a cross sectional assembly view taken along line A-A′ of FIG. 8;

FIG. 11 is an exploded view of a return assembly in accordance with a second embodiment of the present invention; and

FIG. 12 is an exploded view of a return assembly in accordance with a third embodiment of the present invention.

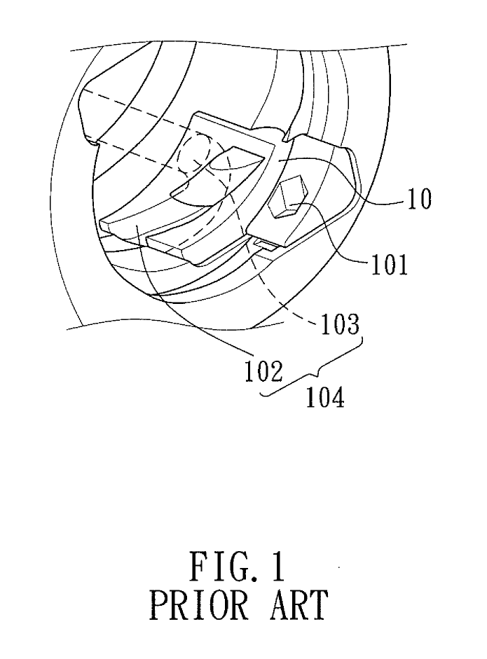

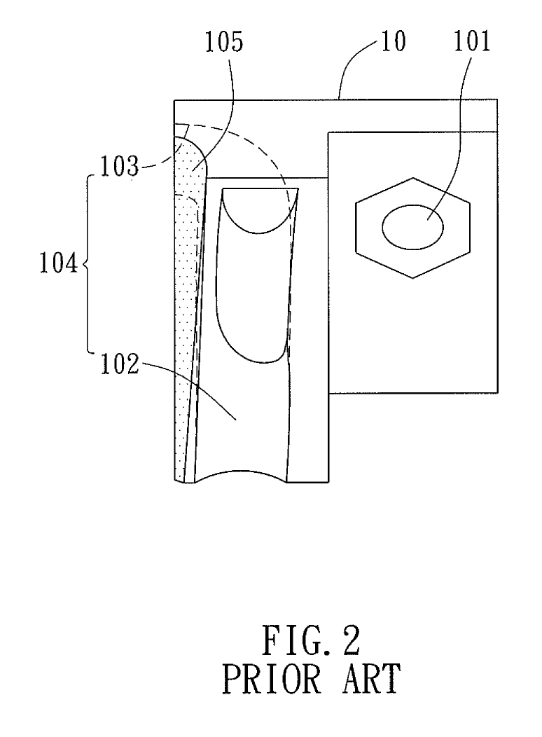

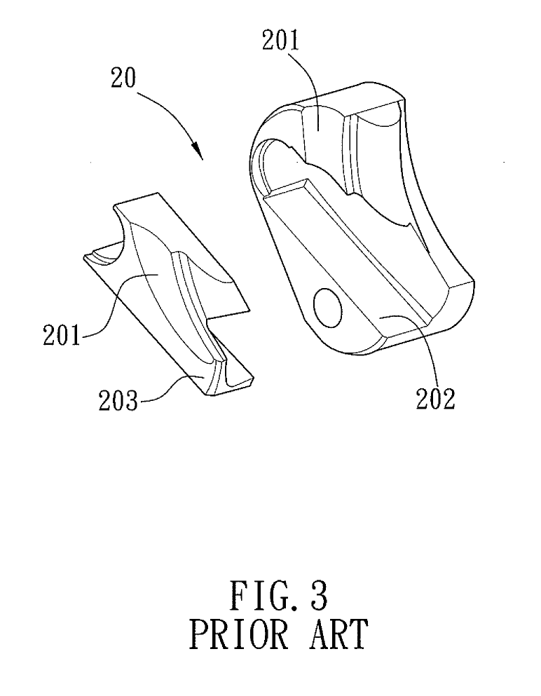

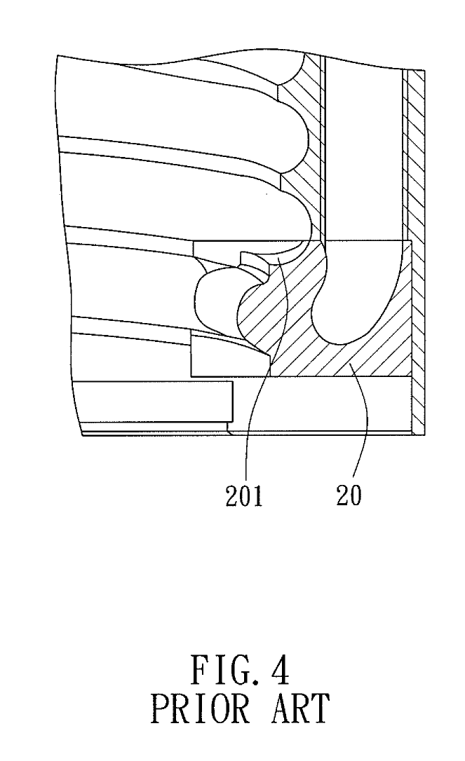

### DETAILED DESCRIPTION OF THE PREFERRED EMBODIMENTS

The present invention will be more clear from the following description when viewed together with the accompanying drawings, which show, for purpose of illustrations only, the preferred embodiment in accordance with the present invention.

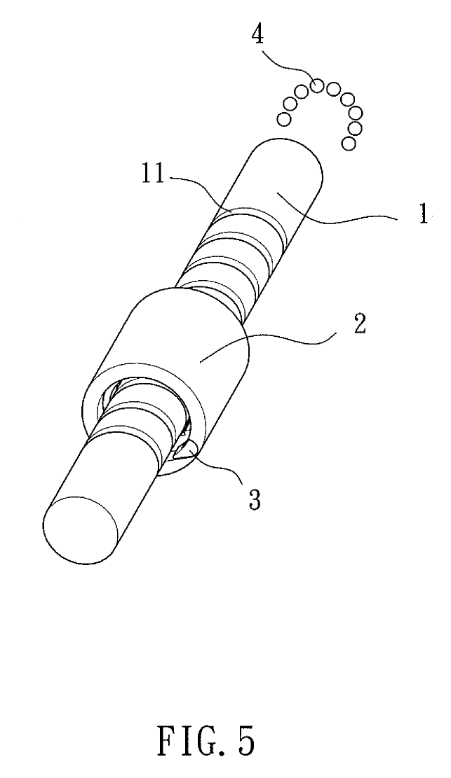

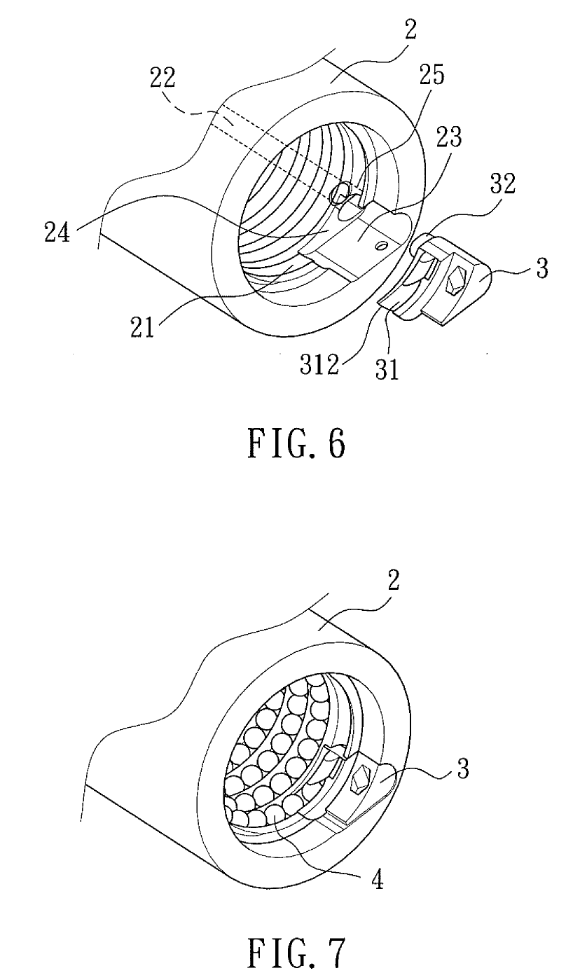

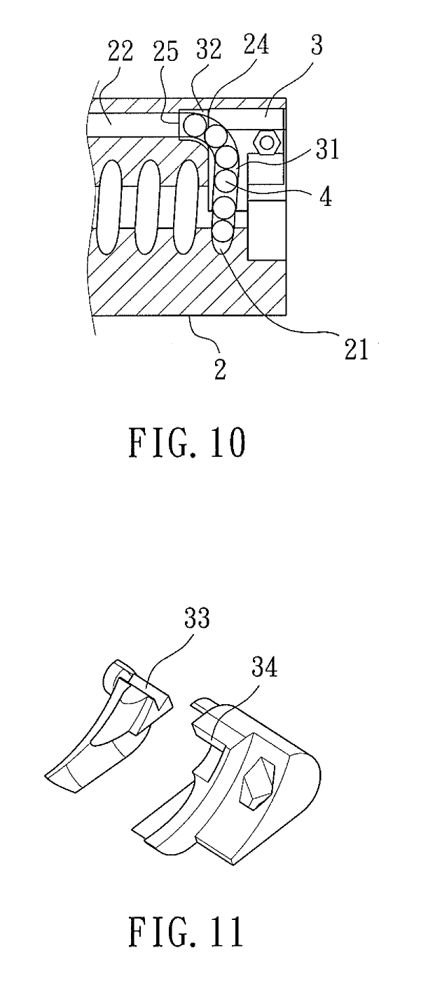

Referring to FIGS. 5-10, a circulation system for a ball screw in accordance with the present invention is illustrated and comprises: a screw 1, a nut 2, a plurality of return assemblies 3 and balls 4. In the outer surface of the screw 1 is formed a helical groove 11 for mating with a helical groove 21 formed in the inner surface of the nut 2. At least one through hole 22 is defined in the nut 2 and has at least one positioning groove 23 formed in either end surface of the nut 2 for insertion of the return assemblies 3. In each of the return assemblies 3 are defined a return path 31 and two open ends 311, 312, and the two open ends 311, 312 are connected to the through hole 22 and the helical groove 21 of the nut 2, respectively. The helical groove 11, 21 of the screw 1 and the nut 2 cooperate with the return path 31 of the return assembly 3 to define an independent circulation path for the balls 4.

The positioning groove 23 of the nut 2 is axially formed with an abutting surface 24 for mating with the return assemblies 3. In the abutting surface 24 is formed a tapered hole 25 for connecting the through hole 22, and the abutting surface 24 doesn't interfere with the helical groove 21. The diameter of the open end 311 of the turning structure is smaller than that of the tapered hole 25. On the open end 312 of the returning assemblies 3 connecting to the through hole 22 is formed a protruding turning structure 32 to be engaged in the tapered hole 25. And in order that the open end 311 and the through hole 22 can be connected more smoothly, the diameter of the open end 311 is designed to be smaller than that of the tapered hole 25.

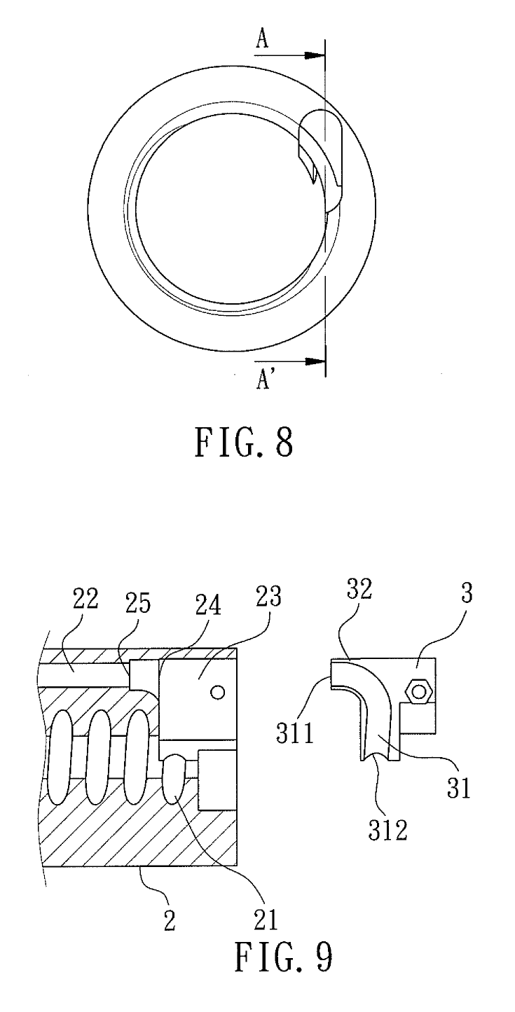

Referring to FIGS. 8-10, FIG. 8 is an assembly side view of showing the return assembly and the nut, the principle of designing a cassette circulation type ball screw is that the lead angle cannot be too small, since a too small lead angle will lead to a too small thread and will destroy the next thread. Therefore, the principle of designing a return path is that the return path is limited and cannot be designed to be too large, and if the return path is too small, the balls cannot roll smoothly through it.

The design of the return assembly of the present invention can solve the problem that the radius of curvature of the conventional return path is relatively small and the positioning groove destroys the helical groove, thus increasing the radius of curvature of the return path, and relatively improving the ease of rolling of the balls during circulation.

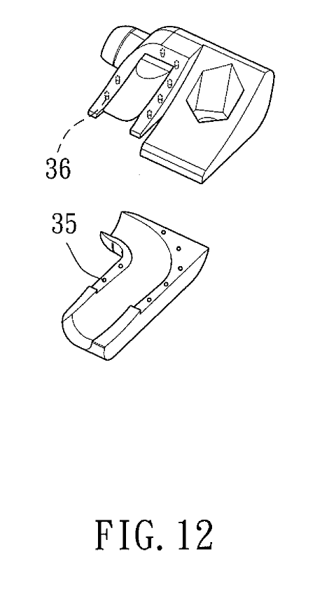

Referring finally to FIGS. 11 and 12, the return assembly of the present invention is not limited to be a unitary structure and can use another design, wherein the return assembly 3 of a second embodiment is axially divided into two separable parts that are connected by dovetail groove 33 and dovetail tongue 34 connection.

In addition to the design of the second embodiment, the return assembly 3 in accordance with a third embodiment of the present invention can also be radially divided into two separable parts that are connected by pin 36 and socket 35 connection.

While we have shown and described various embodiments in accordance with the present invention, it is clear to those skilled in the art that further embodiments may be made without departing from the scope of the present invention.

What is claimed is:

1. A circulation system for a ball screw comprising: a screw, a nut, a plurality of return assemblies and balls, in an outer surface of the screw being formed a helical groove for mating with a helical groove formed in an inner surface of the nut, at least one through hole defined in the nut and having at least one positioning groove formed in either end surface of the nut for insertion of the return assemblies, in each of the return assemblies being defined a return path and two open ends for connecting the through hole and the helical groove of the nut, respectively, the helical groove of the screw and that of the nut cooperate with the return path of the return assembly to define a circulation path for the balls; wherein the positioning groove of the nut is axially formed with an abutting surface for mating with the return assemblies, in the abutting surface is formed a tapered hole for connecting the through hole, and the abutting surface doesn't interfere with the helical groove, on the open end of the returning assemblies connecting to the through hole is formed a protruding turning structure to be engaged in the tapered hole.

2. The circulation system for a ball screw as claimed in claim 1, wherein a diameter of the open end connecting to the through hole is smaller than that of the tapered hole.

3. The circulation system for a ball screw as claimed in claim 1, wherein the return assembly is axially divided into two separable parts that are connected by dovetail groove and dovetail tongue connection.

4. The circulation system for a ball screw as claimed in claim 1, wherein the return assembly is radially divided into two separable parts that are connected by pin and socket connection.
